(19) United States
(12) Patent Application Publication
(10) Pub. No.: US 2009/0234557 A1
(43) Pub. Date: Sep. 17, 2009

(54) CONTROL DEVICE AND CONTROL METHOD FOR SPARK-IGNITION DIRECT-INJECTION INTERNAL COMBUSTION ENGINE

(75) Inventors: Seiji Hirowatari, Aichi-ken (JP); Masahiko Teraoka, Aichi-ken (JP); Jun Maemura, Aichi-ken (JP); Toshitaka Fujiki, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignees: TOYOTA JIDOSHA KABUSHIKI KAISHA, Toyota-shi, Aichi-ken (JP); YAMAHA HATSUDOKI KABUSHIKI KAISHA, Iwata-shi, Shizuoka-ken (JP)

(21) Appl. No.: 11/993,887

(22) PCT Filed: Dec. 4, 2006
(86) PCT No.: PCT/JP2006/324613

§ 371 Date: Dec. 26, 2007

(30) Foreign Application Priority Data
Dec. 8, 2005 (JP) 2005-355085

(51) Int. Cl. F02D 41/30

(52) U.S. Cl. 701/103

(57) ABSTRACT

If two-split injection logic has been adopted, an engine ECU executes a program including the steps of calculating first injection start timing of the two-split injection logic, calculating second injection start timing of the two-split injection logic, calculating a first injection permitted time period A of the two-split injection logic, calculating a first injection required time period B of the two-split injection logic, and adopting single injection logic instead of the two-split injection logic if the first injection start timing A of the two-split injection logic is shorter than the first injection required time period B of the two-split injection logic.

### TECHNICAL FIELD

The present invention relates to a control device of an internal combustion engine in which fuel is directly injected into a cylinder, and more particularly to a control device realizing a satisfactory combustion state in such an internal combustion engine.

### BACKGROUND ART

A direct-injection engine in which fuel is directly injected into a combustion chamber, such as a diesel engine, has been put into practical use today also in the field of a gasoline engine for running of a vehicle or the like. The gasoline engine includes an in-cylinder injector for injecting fuel into the combustion chamber and a spark plug, in which fuel is injected into a cylinder in the compression stroke to conduct semi-stratified combustion when an internal combustion engine is in a low load state such as during idling, whereas fuel is injected into the cylinder in the intake stroke to conduct homogeneous combustion when the internal combustion engine is in a high load state, thus achieving high fuel efficiency and high output.

Japanese Patent Laying-Open No. 2004-116525 relates to a diesel engine, and discloses a method of actuating a fuel injection device performing fuel injection in at least two injection phases that are continuous in terms of time.

The fuel injection device in Japanese Patent Laying-Open No. 2004-116525 is merely directed to a method of actuating a fuel injection device specific to a diesel engine. More specifically, fuel injection is divided into multiple phases and auxiliary (preliminary) pilot injection is performed before main injection, so that main combustion is gradually started and vibration or noise is lowered.

Meanwhile, in the direct-injection gasoline engine as well, two-split fuel injection is performed so that a mixing state of an air-fuel mixture (air and fuel) is improved to realize reduction in a fuel injection amount and combustion stability. Particularly during a cold state in which combustion efficiency is not satisfactory, such function and effect is significant. Here, if time to start second injection comes before first injection ends in two-split injection in the direct-injection gasoline engine, the first fuel injection continues to the second fuel injection, and injection is performed substantially once.

In such a case, shortage of fuel by an amount that could not be injected in the first injection is caused, and the air-fuel ratio becomes lean. At a normally set fuel pressure, setting may be such that the first fuel injection does not overlap with the second fuel injection. If a pressure of fuel (hereinafter, may be referred to as fuel pressure) supplied to a direct injector is lowered, however, a time period for injecting the same amount of fuel becomes longer (in some cases, fuel pressure may be lowered intentionally in such a manner). Then, the first fuel injection continues to the second fuel injection. In addition to such fuel pressure lowering, if a temperature of intake air is extremely low and charging efficiency is high (mass flow rate is high), air mass is great, although air volume is small. Accordingly, in order to control the air-fuel ratio, a required fuel injection amount becomes greater. Then, the time period for the first fuel injection becomes longer and the first injection continues to the second fuel injection.

Japanese Patent Laying-Open No. 2004-116525 described above, however, aims to achieve combustion stability in the diesel engine, and it is different in its object from the direct-injection gasoline engine where fuel is injected in two-split injection. Therefore, it is difficult to apply the fuel injection device in this publication as it is.

### DISCLOSURE OF THE INVENTION

The present invention was made to solve the above-described problems. An object of the present invention is to provide a control device and a control method for a spark-ignition direct-injection internal combustion engine realizing a satisfactory combustion state by means of two-split injection logic in which fuel is injected in two-split injection in a fuel injection process (particularly in a cold state).

A control device according to the present invention controls a spark-ignition direct-injection internal combustion engine including a fuel injection mechanism for directly injecting fuel into a cylinder. The control device controls the fuel injection mechanism for fuel injection into the cylinder, by adopting, in fuel injection process, any one of single injection logic in which fuel is injected once from the fuel injection mechanism and two-split injection logic in which fuel is injected at least twice from the fuel injection mechanism. If first fuel injection and second fuel injection of the two-split injection logic overlap with each other while the two-split injection logic is adopted, the control device changes the two-split injection logic to the single injection logic.

According to the present invention, two-split injection logic is adopted in some cases, for example, in the direct-injection gasoline engine, in order to reduce an injection amount and stabilize combustion by improving a mixing state of the air-fuel mixture (air and fuel) by injecting fuel in two-split injection (particularly in the cold state where a combustion state is not preferable). If the second fuel injection is started before the first fuel injection of the two-split injection logic ends (before fuel in an amount required in the first injection is injected), however, the total fuel injection amount is insufficient and the air-fuel mixture in the combustion chamber becomes lean. Accordingly, in such a case, the two-split injection logic is changed to the single injection logic, so that satisfactory air-fuel ratio can be maintained. As the two-split injection logic is adopted otherwise, the combustion state can be improved particularly in the cold state. Consequently, a control device of a spark-ignition direct-injection internal combustion engine realizing a satisfactory injection state when fuel is injected in two-split injection in the fuel injection process can be provided.

Preferably, the control device calculates a permitted time period during which the first fuel injection is permitted, end of the permitted time period being set as timing of start of the second fuel injection, calculates a required time period required for injecting fuel in an amount required in the first fuel injection, and determines that the first fuel injection and the second fuel injection overlap with each other if the required time period is longer than the permitted time period and changes the two-split injection logic to the single injection logic.

According to the present invention, the permitted time period during which the first fuel injection is permitted, end of which being set as timing of start of the second fuel injection, is calculated, and whether the two-split injection logic should be changed to the single injection logic can be determined.

More preferably, the control device calculates the permitted time period during which the first fuel injection is permitted, start of the permitted time period being set as timing of start of the first fuel injection and end of the permitted time period being set as timing of start of the second fuel injection.

According to the present invention, the permitted time period during which the first fuel injection is permitted, start of which being set as timing of start of the first fuel injection of the two-split injection logic and end of which being set as timing of start of the second fuel injection of the two-split injection logic, is calculated, and whether the two-split injection logic should be changed to the single injection logic can be determined.

More preferably, the control device calculates a permitted time period during which the first fuel injection is permitted, based on information that shorter time period is set as engine speed of the internal combustion engine is higher, calculates a required time period required for injecting fuel in an amount required in the first fuel injection, and determines that the first fuel injection and the second fuel injection overlap with each other if the required time period is longer than the permitted time period and changes the two-split injection logic to the single injection logic.

According to the present invention, the first fuel injection is determined as overlapping with the second fuel injection based on the situation that the required time period is longer than the permitted time period, without operating the permitted time period, by using the information set in advance that the permitted time period is shorter as the engine speed is higher, and the two-split injection logic can be changed to the single injection logic.

A control device according to another aspect of the present invention controls a spark-ignition direct-injection internal combustion engine including a fuel injection mechanism directly injecting fuel into a cylinder. The control device controls the fuel injection mechanism for fuel injection into the cylinder, by adopting, in fuel injection process, any one of single injection logic in which fuel is injected once from the fuel injection mechanism and two-split injection logic in which fuel is injected at least twice from the fuel injection mechanism. If first fuel injection and second fuel injection of the two-split injection logic overlap with each other while the two-split injection logic is adopted, the control device performs correction for injecting fuel in corrected amount in the first fuel injection and the second fuel injection, by subtracting an amount of injection corresponding to overlapped portion from an amount of injection in the first fuel injection and by adding the amount of injection corresponding to the overlapped portion to an amount of injection in the second fuel injection.

According to the present invention, the two-split injection logic is adopted in some cases in the direct-injection gasoline engine, in order to reduce an injection amount and stabilize combustion by improving a mixing state of the air-fuel mixture (air and fuel) by injecting fuel in two-split injection (particularly in the cold state where a combustion state is not preferable). If the second fuel injection is started before the first fuel injection of the two-split injection logic ends (before fuel in an amount required in the first injection is injected), however, the total fuel injection amount is insufficient and the air-fuel mixture in the combustion chamber becomes lean. Accordingly, in such a case, shortage caused by the start of the second fuel injection while the first injection of the two-split injection logic is being performed is calculated. Such shortage is subtracted from the amount of first injection of the two-split injection logic to calculate the amount of first injection of the two-split injection logic. In addition, the shortage is added to the amount of second injection of the two-split injection logic to calculate the amount of second injection of the two-split injection logic. Thus, fuel can be injected in two-split injection, without shortage in the total fuel injection amount being caused. Accordingly, the combustion state can be improved particularly in the cold state. Consequently, a control device of a spark-ignition direct-injection internal combustion engine realizing a satisfactory injection state when fuel is injected in two-split injection in the fuel injection process can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall configuration diagram of an engine controlled by an engine control device according to the first embodiment of the present invention.

FIG. 2 is a flowchart showing a control configuration of a program executed by an engine ECU serving as the engine control device according to the first embodiment of the present invention.

FIGS. 3 and 4 illustrate a fuel injection state when the program in FIG. 2 is executed.

FIG. 5 is a flowchart showing a control configuration of a program executed by an engine ECU serving as an engine control device according to the second embodiment of the present invention.

FIG. 6 shows a map stored in the engine ECU in FIG. 5.

FIG. 7 is a flowchart showing a control configuration of a program executed by an engine ECU serving as an engine control device according to the third embodiment of the present invention.

FIGS. 8 and 9 illustrate a fuel injection state when the program in FIG. 7 is executed.

### BEST MODES FOR CARRYING OUT THE INVENTION

An embodiment of the present invention will be described hereinafter with reference to the drawings. In the description below, the same elements have the same reference characters allotted. Their label and function are also identical. Therefore, detailed description thereof will not be repeated. It is noted that the term “logic” used herein or in CLAIMS refers to “control” or “control state”.

### First Embodiment

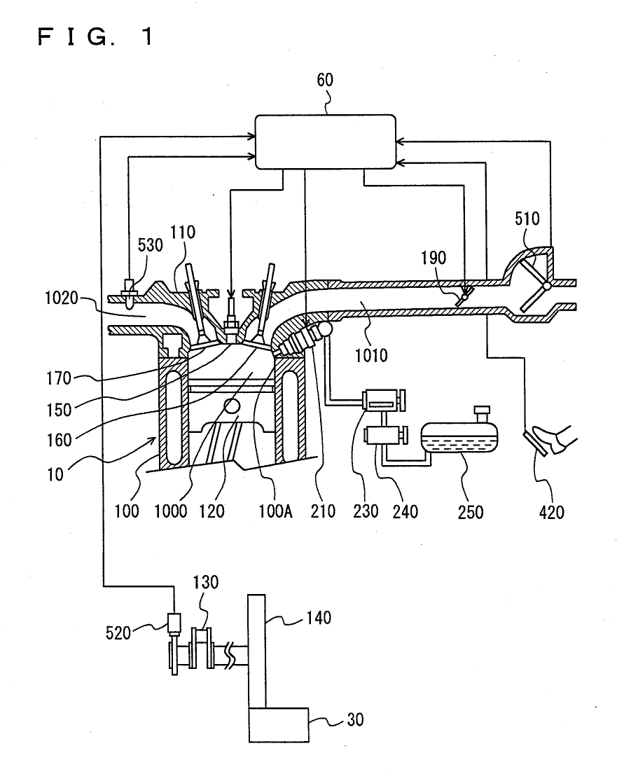

FIG. 1 shows an overall configuration diagram of a direct-injection engine controlled by an engine control device according to the present embodiment.

In an engine 10, a cylinder head 110 is attached above a cylinder block 100 in a manner covering the same, and a piston 120 is slidably held within a cylinder 100A formed in cylinder block 100. Vertical reciprocating motion of piston 120 within cylinder 100A is converted to rotational movement of a crankshaft 130 and transmitted to a transmission and the like. Crankshaft 130 is connected to a starter 30 with a flywheel 140 being interposed, at the time of start of the engine.

A combustion chamber 1000 is formed above piston 120, with cylinder block 100 and cylinder head 110 forming the wall of the chamber. In combustion chamber 1000, combustion of the air-fuel mixture is conducted, and explosive force in combustion causes piston 120 to carry out vertical reciprocating motion. A spark plug 150 provided in such a manner as penetrating cylinder head 110 and projecting in combustion chamber 1000 ignites the air-fuel mixture.

The air composing the air-fuel mixture is supplied through cylinder head 110 and an intake manifold 1010 formed within an intake pipe connected thereto. In addition, exhaustion from combustion chamber 1000 is carried out through an exhaust manifold 1020. An intake valve 160 switching between connection/disconnection between intake manifold 1010 and combustion chamber 1000 and an exhaust valve 170 switching between connection/disconnection between exhaust manifold 1020 and combustion chamber 1000 are attached to cylinder head 110.

A flap-like throttle valve 190 is provided in the intake pipe, and air flow in intake manifold 1010 is regulated in accordance with opening of throttle valve 190.

Fuel composing the air-fuel mixture is supplied by an electromagnetic in-cylinder injector 210. In-cylinder injector 210 is provided in such a manner as penetrating cylinder head 110, and injects fuel into combustion chamber 1000 from its tip-end nozzle portion.

Fuel is supplied to in-cylinder injector 210 in such a manner that fuel suctioned from a fuel tank 250 is pressurized in two stages by a low-pressure pump 240 and a high-pressure pump 230. High-pressure pump 230 is driven by motive power transmitted from crankshaft 130 of engine 10 via a belt and the like. On the other hand, low-pressure pump 240 is driven by electric power.

In addition, an engine control computer (hereinafter, referred to as an engine ECU (Electronic Control Unit)) 60 controlling each part of the engine such as spark plug 150, throttle valve 190, in-cylinder injector 210, and the like is provided. Engine ECU 60 has a general configuration including a CPU (Central Processing Unit), an RAM (Random Access Memory), an ROM (Read Only Memory), and the like. Engine ECU 60 actuates spark plug 150 in response to a detection signal or the like from various sensors, outputs a control signal to throttle valve 190 to adjust a position of throttle valve 190 (throttle position), and supplies power to in-cylinder injector 210 using a control signal to open the nozzle of in-cylinder injector 210 at prescribed timing for a prescribed time period.

It is noted that engine ECU 60 performs fuel injection twice using in-cylinder injector 210. For example, the first fuel injection is started at a crank angle of 3000 BTDC, while the second fuel injection is started at a crank angle of 140° BTDC. If fuel injection is started at such timing, engine ECU 60 solves the problem of continuation of two fuel injections.

Examples of the sensors supplying a signal to engine ECU 60 include a mass flowmeter 510 measuring flow rate of air that flows through intake manifold 1010, a crank angle sensor 520, an A/F sensor 530, a coolant temperature sensor detecting an engine coolant temperature representing an engine temperature, and the like. When a driver manipulates a key at the time of start, an ignition (IG)-on signal and a starter-on signal are input to engine ECU 60, and when the driver presses down an accelerator pedal 420, an amount of pressing down is input to engine ECU 60.

Engine ECU 60 controls a fuel injection amount based on an intake air amount detected by mass flowmeter 510 and the like. Here, engine ECU 60 controls an injection amount and injection timing in accordance with engine speed and engine load based on a signal from each sensor, such that an optimal combustion state is attained. In engine 10, in order to directly inject fuel into the cylinder, injection timing control and injection amount control are simultaneously carried out. In addition, engine ECU 60 controls ignition timing based on a signal detected by crank angle sensor 520, a cam position sensor, and the like (including a knock sensor and the like), such that optimal ignition timing is set. As a result of such control, high output and low emission of engine 10 are both achieved.

In addition, engine ECU 60 controls high-pressure pump 230 so as to control the pressure of fuel supplied to in-cylinder injector 210. Here, for example, high-pressure pump 230 is controlled in the following manner, so as to control the pressure of the fuel.

High-pressure pump 230 includes a pump plunger carrying out reciprocating motion in the cylinder as a result of rotation of a cam, and a pressurizing chamber constituted of the cylinder and the pump plunger. A pump supply pipe communicating to a feed pump that feeds fuel from the fuel tank, a return pipe allowing fuel to flow out from the pressurizing chamber so that the fuel returns to the fuel tank, and a high-pressure delivery pipe delivering the fuel in the pressurizing chamber to in-cylinder injector 210 are connected to the pressurizing chamber. In addition, an electromagnetic spill valve that opens/closes so as to allow connection/disconnection between the pump supply pipe, the high-pressure delivery pipe and the pressurizing chamber is provided in high-pressure pump 230.

When the electromagnetic spill valve is open and the pump plunger moves in a direction increasing a volume of the pressurizing chamber, that is, when high-pressure pump 230 is in the intake stroke, fuel is suctioned from the pump supply pipe into the pressurizing chamber. On the other hand, when the electromagnetic spill valve is closed while the pump plunger moves in a direction decreasing a volume of the pressurizing chamber, that is, while high-pressure pump 230 is in the delivery process, the pump supply pipe and the return pipe are disconnected from the pressurizing chamber, and the fuel in the pressurizing chamber is delivered to in-cylinder injector 210 through a high-pressure delivery pipe.

With such high-pressure pump 230, the fuel is delivered to in-cylinder injector 210 only during a valve-closing period of the electromagnetic spill valve in the delivery process. Accordingly, by controlling the valve-closing start timing of the electromagnetic spill valve (by adjusting a period during which the electromagnetic spill valve is closed), a fuel delivery amount is adjusted. Namely, by advancing the valve-closing start timing of the electromagnetic spill valve for extending the valve-close period, the fuel delivery amount becomes greater. On the other hand, by delaying the valve-closing start timing of the electromagnetic spill valve for shortening the valve-close period, the fuel delivery amount becomes smaller. As the fuel delivery amount is greater, the pressure of fuel in the high-pressure delivery pipe is raised. As the fuel delivery amount is smaller, the pressure of fuel in the high-pressure delivery pipe is lowered.

As described above, the fuel fed from the feed pump is pressurized by high-pressure pump 230 and the pressurized fuel is delivered to in-cylinder injector 210 at an appropriate fuel pressure, so that fuel injection can properly be performed also in the internal combustion engine where fuel is directly injected and supplied to the combustion chamber.

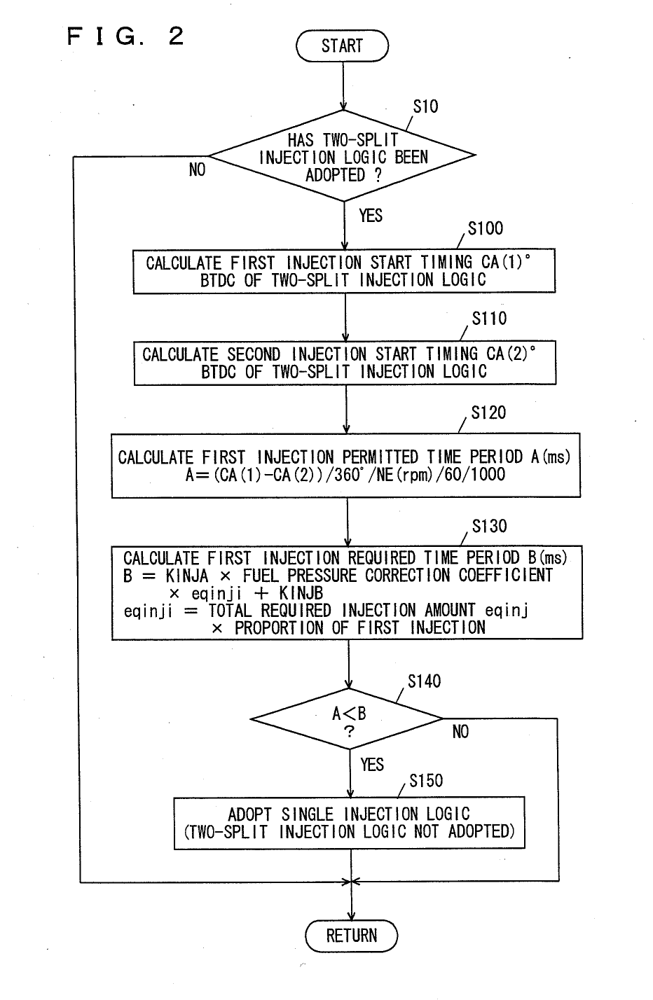

A control configuration of a program executed by engine ECU 60 according to the present embodiment will be described with reference to FIG. 2. It is noted that the program is one subroutine program of the programs executed in engine ECU 60, and it is executed repeatedly every prescribed cycle time.

In step (hereinafter, step is abbreviated as S) 10, engine ECU 60 determines whether the two-split injection logic has been adopted or not. For example, in the cold state, the two-split injection logic is adopted. If the two-split injection logic has been adopted (YES in S10), the process proceeds to S100. Otherwise (NO in S10), the process ends.

In S100, engine ECU 60 calculates first injection start timing CA (1)° BTDC of the two-split injection logic. As described above, for example, CA (1)° BTDC is set to 3000 BTDC.

In S110, engine ECU 60 calculates second injection start timing CA (2)° BTDC of the two-split injection logic. As described above, for example, CA (2)° BTDC is set to 140° BTDC.

In S120, engine ECU 60 calculates a first injection permitted time period A (ms). Here, A is calculated in the following equation: A=(CA (1)-CA (2))/360/engine speed NE/60/1000 (ms). It is noted that engine speed NE is expressed in the unit rpm.

In S130, engine ECU 60 calculates a first injection required time period B (ms). Here, B is calculated in the following equation: B=KINJA×fuel pressure correction coefficient×eqinji+KINJB (ms). It is noted that KINJA represents inclination of a portion at which linear relation of Q (injection amount)−τ(injection time period) characteristic at a basic fuel pressure (for example, 10 MPa) is satisfied. The fuel pressure correction coefficient is a coefficient of correction for the Q−τ characteristic at the basic fuel pressure above. A first injection required amount eqinji is obtained by calculating total required injection amount eqinj×proportion of first injection. KINJB represents an invalid injection time period.

In S140, engine ECU 60 determines whether first injection permitted time period A (ms) is shorter than first injection required time period B (ms). If first injection permitted time period A (ms)<first injection required time period B (ms) (YES in S140), the process proceeds to S150. Otherwise (NO in S140), the process ends (in such a case, as the processing in S150 is not performed, the two-split injection logic is adopted).

In S150, engine ECU 60 adopts the single injection logic, instead of the two-split injection logic that has been adopted, and performs single fuel injection.

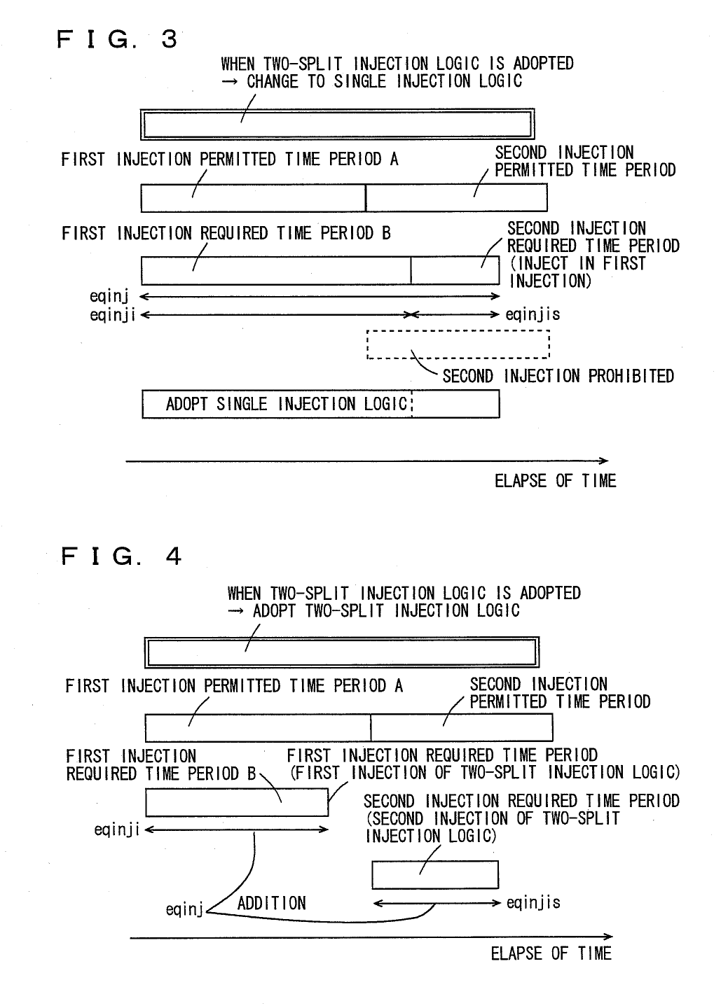

An operation in a case where the engine controlled by engine ECU 60 according to the present embodiment adopts the two-split injection logic, based on the configuration and the flowchart as above, will be described with reference to FIGS. 3 and 4.

For example, first injection start timing CA (1)° BTDC is calculated as 300° BTDC (S100). For example, second injection start timing CA (2)° BTDC is calculated as 140° BTDC (S110).

First injection permitted time period A (ms) is obtained by calculating (CA (1)−CA (2))/360/engine speed NE/60/1000 (S120), and first injection required time period B (ms) is obtained by calculating KINJA×fuel pressure correction coefficient×eqinji+KINJB (S130).

[Case of First Injection Permitted Time Period A<First Injection Required Time Period B]

For example, if first injection required time period B of the two-split injection logic is longer than first injection permitted time period A (YES in S140) as shown in FIG. 3 as a result that the fuel pressure is low, charging efficiency of the intake air is high and total required amount eqinj is great, or the like, the single injection logic instead of the two-split injection logic is adopted (S150).

Here, as shown in FIG. 3, the second injection required time period is added to the first injection required time period and fuel in total required injection amount eqinj is injected in the first injection, thus satisfying the total required injection amount.

[Case of First Injection Permitted Time Period A≧First Injection Required Time Period B]

For example, if first injection required time period B of the two-split injection logic is not longer than first injection permitted time period A (NO in S140) as shown in FIG. 4 as a result that the fuel pressure is sufficiently high, charging efficiency of the intake air is low and total required amount eqinj is small, or the like, the two-split injection logic is adopted.

Here, as shown in FIG. 4, fuel in first injection required amount eqinji is injected in the first injection and fuel in second injection required amount eqinjis is injected in the second injection. Adding injection of twice, total required injection amount eqinj is satisfied.

As described above, according to the engine control device of the present embodiment, if the first injection required time period of the two-split injection logic is longer than the first injection permitted time period when fuel is injected into the cylinder in two-split injection to improve combustion (when the two-split injection logic is adopted), the single injection logic instead of the two-split injection logic is adopted. On the other hand, if the first injection required time period of the two-split injection logic is not longer than the first injection permitted time period, the two-split injection logic is adopted. Therefore, even if the first injection required time period is varied due to fuel pressure fluctuation or charging efficiency fluctuation, fuel in the total required injection amount can be supplied.

### Second Embodiment

A second embodiment of the present invention will now be described. It is noted that description of the structure (including hardware and flowchart) the same as in the first embodiment above will not be repeated.

Engine ECU 60 according to the present embodiment calculates an injection upper limit time period τ (ms) representing the upper limit of the first injection permitted time period, using a map employing first injection permitted time period A calculated in the first embodiment and engine speed NE as parameters. Here, engine ECU 60 executes a program shown in a flowchart different from the flowchart shown in FIG. 2.

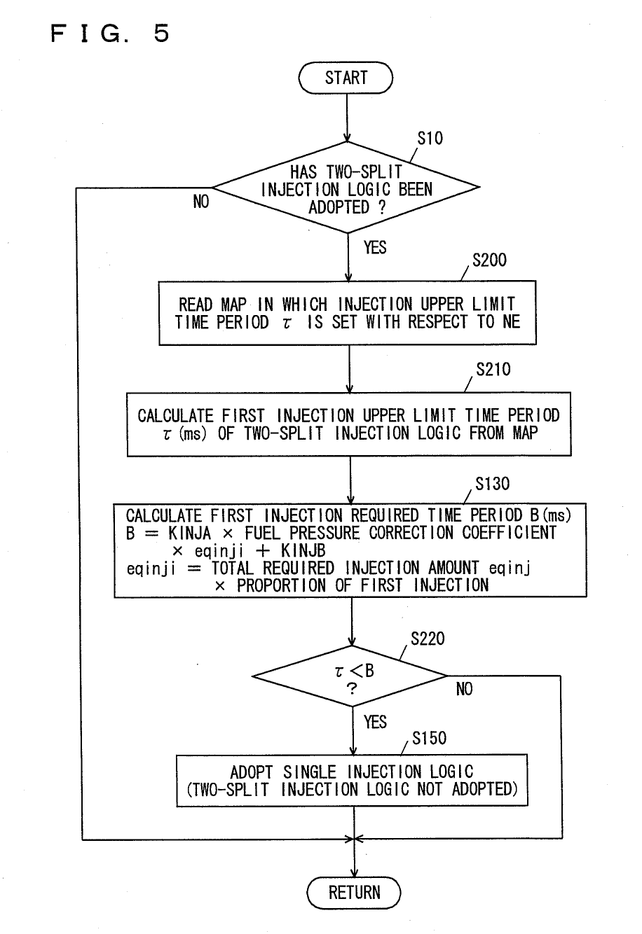

A control configuration of a program executed by engine ECU 60 according to the present embodiment will be described with reference to FIG. 5. It is noted that the processing in the flowchart shown in FIG. 5 the same as that in FIG. 2 is given the same step number. As the processing is the same, detailed description will not be repeated.

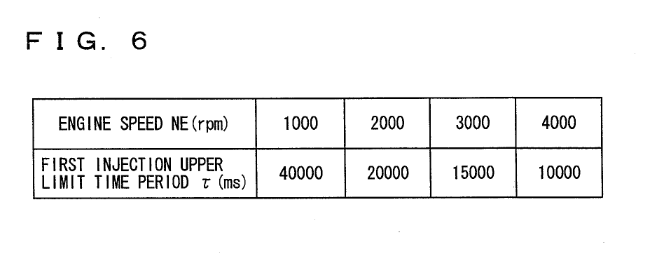

In S200, engine ECU 60 reads a map (see FIG. 6) in which first injection upper limit time period τ (ms) is set with respect to engine speed NE. As shown in FIG. 6, as engine speed NE is higher, first injection upper limit time period τ (ms) is shorter.

In S210, engine ECU 60 calculates first injection upper limit time period τ (ms) from the map in FIG. 6. Here, engine speed NE is calculated based on a signal detected by crank angle sensor 520.

In S220, engine ECU 60 determines whether first injection upper limit time period τ (ms) of the two-split injection logic is shorter than first injection required time period B (ms). If first injection upper limit time period τ (ms) of the two-split injection logic<first injection required time period B (ms) (YES in S220), the process proceeds to S150. Otherwise (NO in S220), the process ends (here, as the processing in S150 is not performed, the two-split injection logic is adopted).

As described above, according to the engine control device in the present embodiment, first injection upper limit time period τ (ms) of the two-split injection logic is set using the engine speed as the parameter, and first injection upper limit time period τ (ms) of the two-split injection logic is compared with first injection required time period B (ms). Then, whether the two-split injection logic is to be adopted or not can be determined. Control is facilitated as compared with the control device according to the first embodiment.

### Third Embodiment

A third embodiment of the present invention will now be described. It is noted that description of the structure (including hardware and flowchart) the same as in the first embodiment above will not be repeated.

In engine 10 controlled by engine ECU 60 according to the present embodiment, if first injection required time period B is longer than first injection permitted time period A, fuel in the entire first injection required amount cannot be injected, and shortage is caused. Accordingly, the shortage is compensated for in the second injection. Here, engine ECU 60 executes a program shown in a flowchart different from the flowchart shown in FIG. 2.

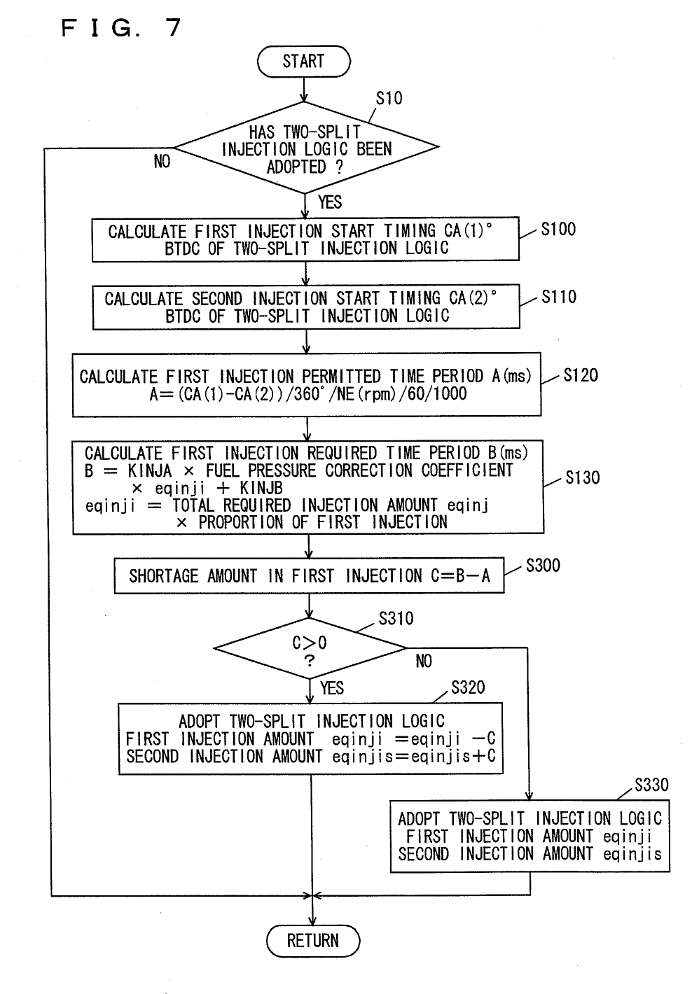

A control configuration of the program executed by engine ECU 60 according to the present embodiment will be described with reference to FIG. 7. It is noted that the processing in the flowchart shown in FIG. 7 the same as that in FIG. 2 is given the same step number. As the processing is the same, detailed description will not be repeated.

In S300, engine ECU 60 calculates a shortage amount C in the first injection of the two-split injection logic by subtracting first injection permitted time period A (ms) from first injection required time period B (ms) of the two-split injection logic.

In S310, engine ECU 60 determines whether shortage amount C in the first injection of the two-split injection logic is greater than 0. If shortage amount C in the first injection of the two-split injection logic is greater than 0 (YES in S310), the process proceeds to S320. Otherwise (NO in S310), the process proceeds to S330.

In S320, engine ECU 60 calculates an amount of first injection eqinji of the two-split injection logic as eqinji=eqinji−C, and calculates an amount of second injection eqinjis of the two-split injection logic as eqinjis=eqinjis+C.

In S330, engine ECU 60 calculates the amount of first injection eqinji of the two-split injection logic and the amount of second injection eqinjis of the two-split injection logic, without considering shortage amount C.

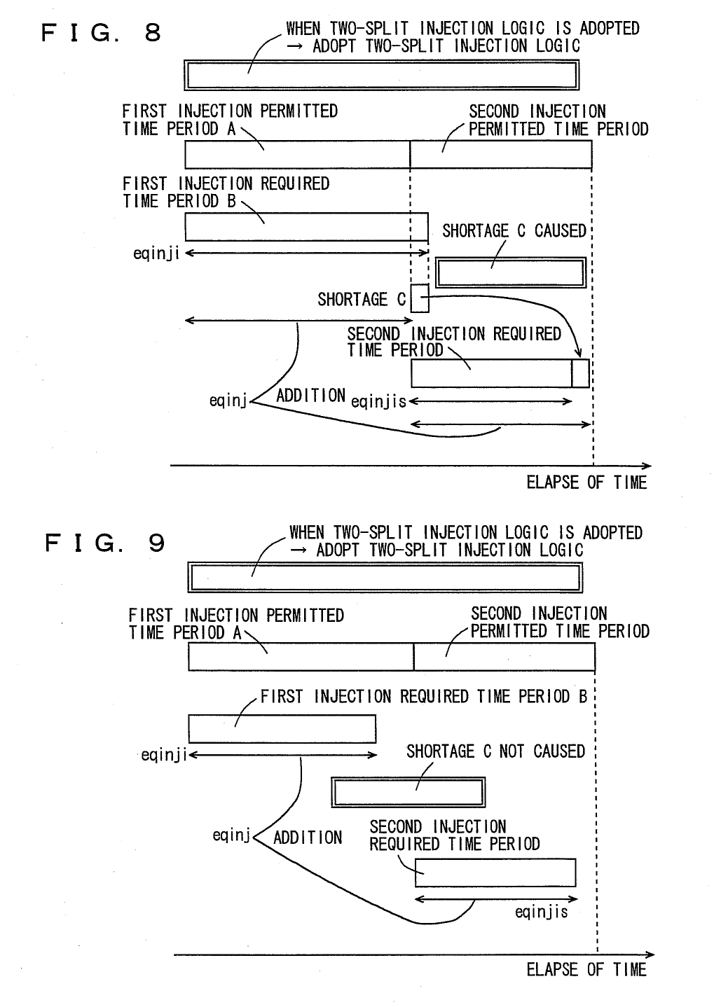

An operation in a case where the engine controlled by engine ECU 60 according to the present embodiment adopts the two-split injection logic, based on the configuration and the flowchart as above, will be described with reference to FIGS. 8 and 9. It is noted that description of the operation in the present embodiment the same as that in the first embodiment will not repeated.

[Case of Shortage Amount in First Injection>0]

For example, if first injection required time period B of the two-split injection logic is longer than first injection permitted time period A of the two-split injection logic as shown in FIG. 8 as a result that the fuel pressure is low, charging efficiency of the intake air is high and total required amount eqinj is great, or the like, that is, if (first injection required time period B−first injection permitted time period A)>0 (YES in S310), amount of first injection eqinji of the two-split injection logic and amount of second injection eqinjis of the two-split injection logic are adjusted (S320).

Here, as shown in FIG. 8, fuel in an amount obtained by subtracting shortage C from amount of first injection eqinji of the two-split injection logic is injected into the cylinder as fuel in the amount of first injection of the two-split injection logic, and fuel in an amount obtained by adding shortage C to amount of second injection eqinjis of the two-split injection logic is injected into the cylinder as fuel in the amount of second injection of the two-split injection logic. Fuel in total required injection amount eqinj is injected in such two injections, thus satisfying the total required injection amount.

[Case of Shortage Amount in First Injection≦0]

For example, if first injection required time period B of the two-split injection logic is not longer than first injection permitted time period A of the two-split injection logic as shown in FIG. 9 as a result that the fuel pressure is sufficiently high, charging efficiency of the intake air is low and total required amount eqinj is small, or the like, that is, if (first injection required time period B−first injection permitted time period A)≦0 (NO in S310), both of the first injection and the second injection are performed without amount of first injection eqinji of the two-split injection logic and amount of second injection eqinjis of the two-split injection logic being adjusted (S330).

Here, as shown in FIG. 9, fuel in the first injection required amount is injected in the first injection of the two-split injection logic and fuel in the second injection required amount is injected in the second injection of the two-split injection logic. Adding injection of twice, eqinj is satisfied and the total required injection amount is satisfied.

As described above, according to the engine control device in the present embodiment, if the first injection required time period of the two-split injection logic is longer than the first injection permitted time period of the two-split injection logic when fuel is injected into the cylinder in two-split injection to improve combustion, fuel shortage in the first injection of the two-split injection logic is compensated for in the second fuel injection of the two-split injection logic. Therefore, even if the first injection required time period is varied due to fuel pressure fluctuation or charging efficiency fluctuation, fuel in the total required injection amount can be supplied.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

1. A control device of a spark-ignition direct-injection internal combustion engine including a fuel injection mechanism directly injecting fuel into a cylinder,
said control device controlling said fuel injection mechanism for fuel injection into the cylinder, by adopting, in fuel injection process, any one of single injection logic in which fuel is injected once from said fuel injection mechanism and two-split injection logic in which fuel is injected at least twice from said fuel injection mechanism, and
if first fuel injection and second fuel injection of said two-split injection logic overlap with each other while said two-split injection logic is adopted, said control device changing said two-split injection logic to said single injection logic.

2. The control device of a spark-ignition direct-injection internal combustion engine according to claim 1, wherein
said control device calculates a permitted time period during which said first fuel injection is permitted, end of the permitted time period being set as timing of start of said second fuel injection,
calculates a required time period required for injecting fuel in an amount required in said first fuel injection, and
determines that the first fuel injection and the second fuel injection overlap with each other if said required time period is longer than said permitted time period, and changes said two-split injection logic to said single injection logic.

3. The control device of a spark-ignition direct-injection internal combustion engine according to claim 2, wherein
said control device calculates the permitted time period during which said first fuel injection is permitted, start of the permitted time period being set as timing of start of said first fuel injection and end of the permitted time period being set as timing of start of said second fuel injection.

4. The control device of a spark-ignition direct-injection internal combustion engine according to claim 1, wherein
said control device calculates a permitted time period during which said first fuel injection is permitted, based on information that shorter time period is set as engine speed of said internal combustion engine is higher,
calculates a required time period required for injecting fuel in an amount required in said first fuel injection, and
determines that the first fuel injection and the second fuel injection overlap with each other if said required time period is longer than said permitted time period, and changes said two-split injection logic to said single injection logic.

5. A control device of a spark-ignition direct-injection internal combustion engine including a fuel injection mechanism directly injecting fuel into a cylinder,
said control device controlling said fuel injection mechanism for fuel injection into the cylinder, by adopting, in fuel injection process, any one of single injection logic in which fuel is injected once from said fuel injection mechanism and two-split injection logic in which fuel is injected at least twice from said fuel injection mechanism, and
if first fuel injection and second fuel injection of said two-split injection logic overlap with each other while said two-split injection logic is adopted, said control device performing correction for injecting fuel in corrected amount in said first fuel injection and said second fuel injection, by subtracting an amount of injection corresponding to overlapped portion from an amount of injection in said first fuel injection and by adding the amount of injection corresponding to the overlapped portion to an amount of injection in said second fuel injection.

6. A control device of a spark-ignition direct-injection internal combustion engine including a fuel injection mechanism directly injecting fuel into a cylinder, comprising:
control means for controlling said fuel injection mechanism for fuel injection into the cylinder, by adopting, in fuel injection process, any one of single injection logic in which fuel is injected once from said fuel injection mechanism and two-split injection logic in which fuel is injected at least twice from said fuel injection mechanism; and
changing means for changing said two-split injection logic to said single injection logic if first fuel injection and second fuel injection of said two-split injection logic overlap with each other while said two-split injection logic is adopted.

7. The control device of a spark-ignition direct-injection internal combustion engine according to claim 6, wherein
said changing means includes
calculation means for calculating a permitted time period during which said first fuel injection is permitted, end of the permitted time period being set as timing of start of said second fuel injection,
means for calculating a required time period required for injecting fuel in an amount required in said first fuel injection, and
means for determining that the first fuel injection and the second fuel injection overlap with each other if said required time period is longer than said permitted time period and changing said two-split injection logic to said single injection logic.

8. The control device of a spark-ignition direct-injection internal combustion engine according to claim 7, wherein
said calculation means includes means for calculating the permitted time period during which said first fuel injection is permitted, start of the permitted time period being set as timing of start of said first fuel injection and end of the permitted time period being set as timing of start of said second fuel injection.

9. The control device of a spark-ignition direct-injection internal combustion engine according to claim 6, wherein
said changing means includes
calculation means for calculating a permitted time period during which said first fuel injection is permitted, based on information that shorter time period is set as engine speed of said internal combustion engine is higher,
means for calculating a required time period required for injecting fuel in an amount required in said first fuel injection, and
means for determining that the first fuel injection and the second fuel injection overlap with each other if said required time period is longer than said permitted time period and changing said two-split injection logic to said single injection logic.

10. A control device of a spark-ignition direct-injection internal combustion engine including a fuel injection mechanism directly injecting fuel into a cylinder, comprising:
control means for controlling said fuel injection mechanism for fuel injection into the cylinder, by adopting, in fuel injection process, any one of single injection logic in which fuel is injected once from said fuel injection mechanism and two-split injection logic in which fuel is injected at least twice from said fuel injection mechanism; and
correction means for performing correction for injecting fuel in corrected amount in first fuel injection and second fuel injection, by subtracting an amount of injection corresponding to overlapped portion from an amount of injection in said first fuel injection and by adding the amount of injection corresponding to the overlapped portion to an amount of injection in said second fuel injection, if the first fuel injection and the second fuel injection of said two-split injection logic overlap with each other while said two-split injection logic is adopted.

11. A method of controlling a spark-ignition direct-injection internal combustion engine including a fuel injection mechanism directly injecting fuel into a cylinder, comprising the steps of:
controlling said fuel injection mechanism for fuel injection into the cylinder, by adopting, in fuel injection process, any one of single injection logic in which fuel is injected once from said fuel injection mechanism and two-split injection logic in which fuel is injected at least twice from said fuel injection mechanism; and
changing said two-split injection logic to said single injection logic if first fuel injection and second fuel injection in said two-split injection logic overlap with each other while said two-split injection logic is adopted.

12. The method of controlling a spark-ignition direct-injection internal combustion engine according to claim 11, wherein
said step of changing logic includes the steps of
calculating a permitted time period during which said first fuel injection is permitted, end of the permitted time period being set as timing of start of said second fuel injection,
calculating a required time period required for injecting fuel in an amount required in said first fuel injection, and
determining that the first fuel injection and the second fuel injection overlap with each other if said required time period is longer than said permitted time period and changing said two-split injection logic to said single injection logic.

13. The method of controlling a spark-ignition direct-injection internal combustion engine according to claim 12, wherein
said step of calculating a permitted time period includes the step of calculating the permitted time period during which said first fuel injection is permitted, start of the permitted time period being set as timing of start of said first fuel injection and end of the permitted time period being set as timing of start of said second fuel injection.

14. The method of controlling a spark-ignition direct-injection internal combustion engine according to claim 11, wherein
said step of changing logic includes the steps of
calculating a permitted time period during which said first fuel injection is permitted, based on information that shorter time period is set as engine speed of said internal combustion engine is higher,
calculating a required time period required for injecting fuel in an amount required in said first fuel injection, and
determining that the first fuel injection and the second fuel injection overlap with each other if said required time period is longer than said permitted time period and changing said two-split injection logic to said single injection logic.

15. A method of controlling a spark-ignition direct-injection internal combustion engine including a fuel injection mechanism directly injecting fuel into a cylinder, comprising the steps of:
controlling said fuel injection mechanism for fuel injection into the cylinder, by adopting, in fuel injection process, any one of single injection logic in which fuel is injected once from said fuel injection mechanism and two-split injection logic in which fuel is injected at least twice from said fuel injection mechanism; and
performing correction for injecting fuel in corrected amount in first fuel injection and second fuel injection, by subtracting an amount of injection corresponding to overlapped portion from an amount of injection in said first fuel injection and by adding the amount of injection corresponding to the overlapped portion to an amount of injection in said second fuel injection, if the first fuel injection and the second fuel injection of said two-split injection logic overlap with each other while said two-split injection logic is adopted.
